(19) United States
(12) Patent Application Publication
(10) Pub. No.: US 2025/0028167 A1
(43) Pub. Date: Jan. 23, 2025

(54) TUNABLE OPTICAL COMPONENT

(71) Applicant: OPTOTUNE SWITZERLAND AG, Dietikon (CH)

(72) Inventor: Christopher LANING, Windisch (CH)

(73) Assignee: OPTOTUNE SWITZERLAND AG, Dietikon (CH)

(21) Appl. No.: 18/712,719

(22) PCT Filed: Nov. 23, 2022
(86) PCT No.: PCT/EP2022/083023

§ 371 Date: May 23, 2024

(30) Foreign Application Priority Data
Nov. 23, 2021 (WO) PCT/IB2021/060835
Jan. 27, 2022 (DE) 10 2022 101 932.2

(51) Int. Cl. G02B 26/00; G02B 3/12

(52) U.S. Cl. CPC G02B 26/004; G02B 3/12

(57) ABSTRACT

Tunable optical component (1) comprising a first carrier (10) and a second carrier (20), wherein the first carrier (10) is movable with respect to the second carrier (20), a volume (30) filled with a liquid, wherein the volume is arranged between the first carrier (10) and the second carrier (20) along an optical axis (100) of the optical component (1), an actuator (40) which is arranged to move the first carrier (10) with respect to the second carrier (20) by means of an actuation force, wherein movement of the first carrier (10) with respect to the second carrier (20) changes a shape of the volume (30), and a locking unit (50), wherein the locking unit (50) is arranged to connect the first carrier (10) and the second carrier (20) to one another by means of a releasable connection, wherein in a closed state (51) the locking unit (50) is arranged impede relative motion of the first carrier (10) and the second carrier (20) along the optical axis (100), and in an open state (52) of the locking unit the first carrier (10) is movable with respect to the second carrier (20) along the optical axis (100) of the tunable optical component (1).

A tunable optical component is described herein. The tunable optical component may be a transmission based tunable optical component which interacts with electromagnetic radiation, in particular visible light, by refraction, wherein at least one optical property of the optical component is controllable. Alternatively, the tunable optical component may be a reflection based tunable optical component, which interacts with electromagnetic radiation by reflection. For example, the tunable optical component is a tunable prism, a tunable lens or a deformable or deflectable mirror.

The tunable optical component comprises a first carrier and a second carrier, wherein the first carrier is movable with respect to the second carrier. At least one of the first and the second carrier, in particular both the first and the second carrier comprise an optical surface of the tunable optical component. Here and in the following an optical surface is a surface which is arranged to interact with electromagnetic radiation in an intended manner.

The tunable optical component comprises a volume filled with a liquid, wherein the volume is arranged between the first carrier and the second carrier along an optical axis of the optical component.

The tunable optical component comprises an actuator which is arranged to move the first carrier with respect to the second carrier by means of an actuation force, wherein movement of the first carrier with respect to the second carrier changes a shape of the volume. In particular, the application of the actuation force results in an adjustment of the alignment of the optical surface(s) of the first and/or second carrier with respect to incident light, or the application of the actuation force results in a change of a shape of the optical surface(s) of the first and/or second carrier.

The tunable optical component comprises a locking unit, wherein the locking unit is arranged to connect the first carrier and the second carrier to one another by means of a releasable connection, wherein in a closed state the locking unit is arranged impede relative motion of the first carrier and the second carrier along the optical axis, and in an open state of the locking unit the first carrier is movable with respect to the second carrier along the optical axis of the tunable optical component.

The tunable optical component is based on the following considerations amongst others. In applications where optical properties of the tunable optical component only need to be altered at a low frequency, it is preferable to utilize an actuator which has a low or zero power to hold an intended tuning state of the tunable optical component. However, actuators which require power to maintain a certain tuning state may be preferable, because of their short time to response, their high linearity, their small form factor or other properties.

The tunable optical component described herein comprises a separate locking unit, which is arranged to maintain a dedicated tuning state. Thus, the tunable optical component makes use of the possibility to select the actuator type independently from the property of the actuator of having zero power consumption for maintaining a certain tuning state or high holding power for maintaining a tuning state.

According to one embodiment, the locking unit is in the closed state when no power is supplied to the locking unit and the locking unit is in the open state when power is supplied to the locking unit. In other words, the locking unit has a so called “active open” geometry. Alternatively, the locking unit may be arranged to be in the open state when no power is supplied to the locking unit, which corresponds to a so called “active closed” geometry. The active closed geometry is particularly relevant in cases where the power consumption of the locking unit smaller than the power consumption of the actuator for maintaining a tuning state of the tunable optical component.

According to one embodiment in the closed state the locking unit connects the first carrier and the second carrier my means of a form fitting connections and/or by means of a force fitting connection. In particular, the locking unit may comprise elastic elements which exert normal forces on surfaces of the first and/or second carrier to provide a force fitting connection between the first and second carrier. Furthermore, the locking unit may comprise surfaces with interlacing structure, like a ratchet structure, wherein the relative motion of the first and second carrier is predominantly impeded by means of a form fitting connection between the first carrier and the second carrier.

According to one embodiment, the locking unit is arranged to provide locking forces which act on the first and/or second carrier, and the locking forces are in force equilibrium so that the resulting force is zero. In particular, the locking forces do not result in a motion of the first carrier with respect to the second carrier a long the optical axis. Preferably the locking forces do not result in relative motion of the first carrier with respect to the second carrier in directions obliquely with respect to the optical axis.

According to one embodiment switching between the open and the closed state of the locking unit does not change the relative position of the first carrier and the second carrier with respect to each other. In particular, switching between the closed state and the open state does not alter the position of the first carrier with respect to the second carrier along the optical axis.

According to one embodiment, the locking unit comprises multiple locking elements, wherein each locking element is arranged to apply a locking force to the first or the second carrier in a direction perpendicular to the optical axis, and wherein the locking elements are distributed along the perimeter of the volume.

According to one embodiment, the locking unit comprises at least three locking elements. In particular, the first carrier and the second carrier are at least partially rigid. In this context, partially rigid refers to the portion of the first/second carrier which is being interfaced by means of the actuator and/or the locking unit. Each of the locking elements is arranged to define a relative position of one point of the first carrier with respect to the second carrier along the optical axis.

According to one embodiment, the locking unit comprises locking actuator which arranged to switch between the open and the closed state, wherein the locking actuator comprises one of a shape memory alloy, an electro-permanent magnet or a reluctance actuator. In particular, the locking actuator comprises a shape memory alloy (SMA), which has a wire shape with a main extension direction. The SMA is arranged to contract along the main extension direction when exceeding a transition temperature. For example, the wire is heated above the transition temperature, by applying a current to the wire.

According to one embodiment, the tunable optical component comprises an accelerometer for measuring an acceleration force acting onto the tunable optical component and a control unit controlling the switch between open and closed state of the locking unit, wherein the control unit is arranged to switch the locking unit in the closed state when the accelerometer detects an acceleration force above a threshold acceleration force value. The threshold acceleration force value may be 1 G, preferably 1.5 G or 3 G. Thus, the locking unit may prevent relative motion of the first and the second carrier when it is exposed to high acceleration forces, like in a drop event.

According to one embodiment, the tunable optical component is a tunable lens, wherein the first carrier is deformable, and the actuator is arranged to alter a shape of the first carrier along the optical axis by applying an actuation force.

According to one embodiment the first carrier comprises a flexible membrane and a shaping element, wherein the membrane comprises a first optical surface of the tunable optical component. The shaping element extends perimetrically around the first optical surface and the shaping element is elastically deformable in a direction along the optical axis. The actuator is attached to the shaping element at multiple actuation points, and the actuator is arranged to control a shape of the first optical surface by adjusting a position of the shaping element at the actuation points with respect to the second carrier in a direction along the optical axis at each actuation point individually. The tunable optical component comprises at least six actuation points to control at least one of the following optical properties: sphere, prism and/or astigmatism.

In particular, the actuator comprises multiple pulling ropes, wherein each pulling rope is attached to a different actuation point and wherein each pulling rope comprises a different SMA element which is arranged to provide an actuation force. This type of actuator is described in connection with the German patent application 102021105705.1, the content of which is included by reference.

According to one embodiment the number of locking elements equals at least the number of actuation points, and each of said locking elements is arranged to impede relative motion of one of the actuation points with respect to the second carrier in a direction along the optical axis individually.

According to one embodiment, the locking unit is arranged to impede relative motion of all actuation points simultaneously. In particular, the locking unit comprises a single locking actuator, which is arranged to control the switch between the closed and open state synchronously.

According to one embodiment the tunable optical component is a tunable lens, and the first carrier comprises the flexible membrane and the shaping element, wherein the membrane comprises the first optical surface of the tunable optical component. The shaping element extends perimetrically around the first optical surface, and the shaping element is rigid in a direction along the optical axis. The actuator is arranged to control a shape of the first optical surface by adjusting a position of the shaping element with respect to the second carrier in a direction along the optical axis.

According to one embodiment, an adjustment of the relative position of the first carrier and the second carrier alters the pressure of the liquid in the volume, which causes the membrane to bend.

According to one embodiment, the first carrier and the second carrier are connected by a hinge, wherein the hinge defines an axis of rotation of the first carrier with respect to the second carrier. For example, the actuator is attached to a single point of the first carrier and at most to two points of the second carrier.

According to one embodiment the axis of rotation extends tangentially along the volume as seen in a top view along the optical axis. In particular, the axis of rotation does not extend through the center of the volume as seen in a top view along the optical axis.

According to one embodiment the tunable optical component is a tunable prism and the first carrier and the second carrier are rigid transparent elements, and the actuator is arranged to tilt the first carrier with respect to the second carrier.

According to one embodiment the tunable optical component comprises a position sensing unit, which is arranged to detect a relative position of the first carrier with respect to the second carrier. The position sensing unit may comprise a hall sensor, which is arranged to determine relative position of the first carrier with respect to the second carrier.

According to one embodiment, the position sensing unit is arranged to detect the relative position of each actuation point with respect to the second carrier.

According to one embodiment, the actuator comprises a shape memory alloy providing an actuation force and a retention element providing a retention force, wherein the retention force is opposed to the actuation force, and the retention element comprises an elastic membrane, wherein the tension of the membrane is increased when the pressure in the volume is increased by means of the actuation force and the tension in the membrane provides the retention force. Alternatively, the retention element comprises a spring element which pushes the first carrier and the second carrier apart, wherein the spring element may comprise a leaf spring extending perimetrically around the volume According to a further alternative, the retention element comprises an retention actuator providing the retention force, wherein the retention actuator may comprise one of a shape memory alloy, an electro-permanent magnet or a reluctance actuator.

According to one embodiment, the actuator comprises an SMA-wire, wherein the SMA wire is guided along the perimeter of the liquid volume, and the length of the SMA-wire along its main extension direction is larger than the distance between the first and the second carrier. (FIG. 11) In particular, the SMA-wire is deflected at least once by resting against the first and/or second carrier.

According to one embodiment, the actuator comprises multiple SMA wires, wherein all of the multiple SMA wires a commonly electrically connected through the first or second carrier. (FIG. 13) Further advantages and advantageous embodiments and further embodiments of the tunable optical component result from the following embodiment examples shown in connection with the figures.

It is shown in:

FIGS. 1, 2 and 3 exemplary embodiments of tunable optical components with a locking unit comprising multiple locking elements in a schematic perspective view;

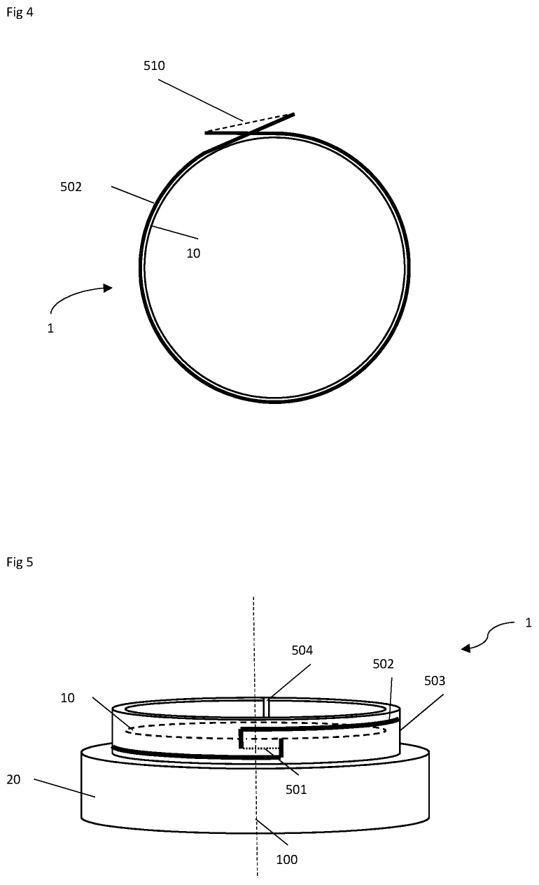

FIGS. 4 and 5 exemplary embodiments of a tunable optical component with a locking unit;

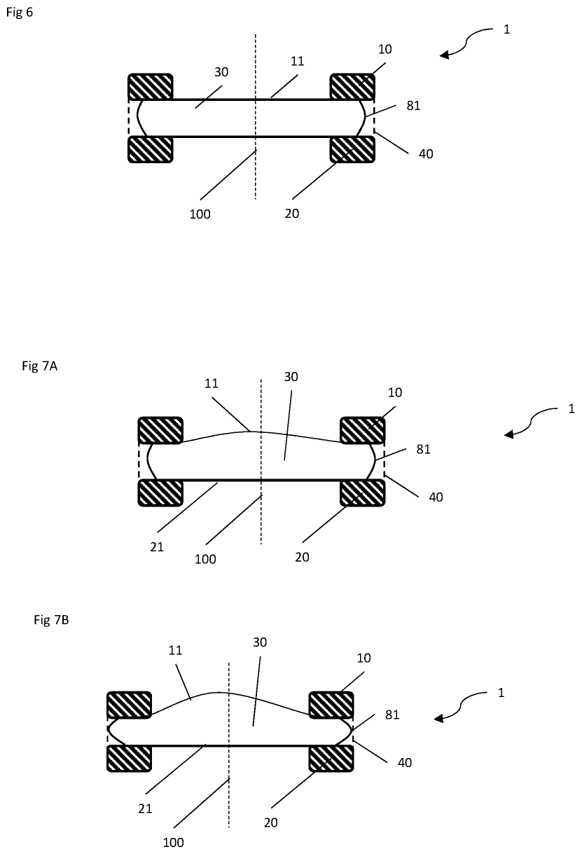

FIG. 6 an exemplary embodiment of a tunable optical component;

FIGS. 7A, 7B, 8, 9 and 10 exemplary embodiments of tunable optical components with a retention element;

FIGS. 11, 12 and 14 exemplary embodiments of tunable optical components with an actuator comprising SMA-wires extending along the circumference of a first and/or second carrier;

FIG. 13 an exemplary embodiment of a tunable optical component with an actuator comprising SMA-wires which have a common electrical connection through the second carrier;

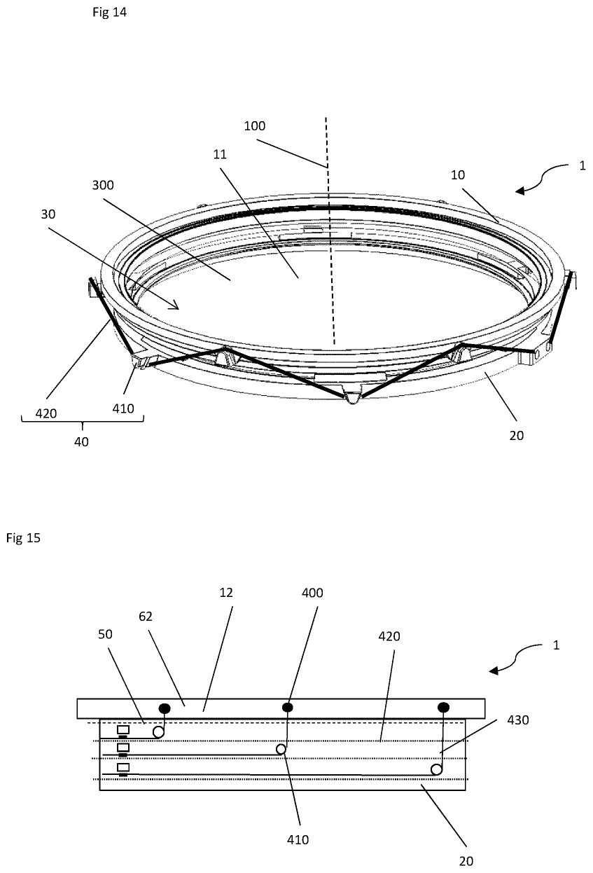

FIG. 15 an exemplary embodiment of a tunable optical component with multiple actuation points;

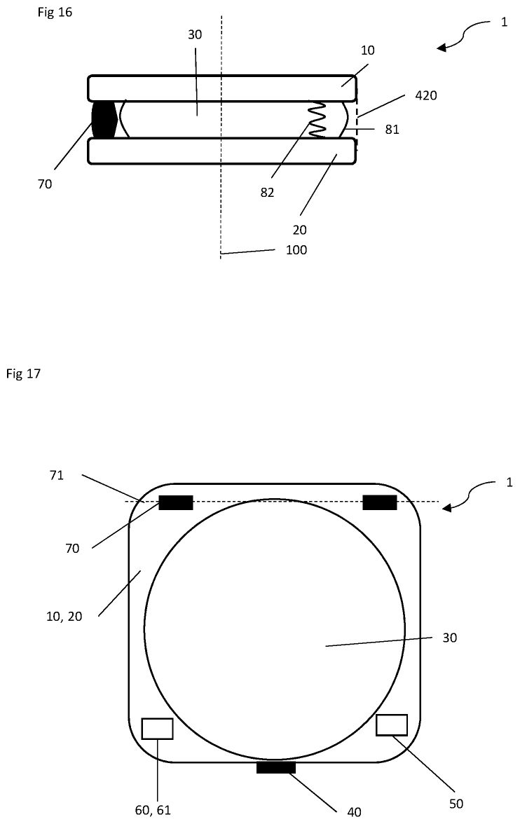

FIGS. 16 and 17 exemplary embodiments of tunable optical components with a hinge.

Elements that are the same, similar or have the same effect are given the same reference signs in the figures. The figures and the proportions of the elements shown in the figures with respect to one another are not to be regarded as to scale. Rather, individual elements may be shown exaggeratedly large for better representability and/or for better comprehensibility.

FIGS. 1 to 3 shows exemplary embodiments of a tunable optical component 1 in a schematic perspective view and an enlarged section (enclosed by dashed lines). As shown in the embodiments of the FIGS. 1 to 3, the tunable optical component 1 comprises a locking unit 50, wherein the locking unit 50 is arranged to connect a first carrier 10 and a second carrier 20 to one another by means of a releasable connection, wherein in a closed state 51 the locking unit 50 is arranged impede relative motion of the first carrier 10 and the second carrier 20 along the optical axis 100, and in an open state 52 of the locking unit 50 the first carrier 10 is movable with respect to the second carrier 20 along the optical axis 100 of the tunable optical component 1.

The locking unit 50 comprises multiple locking elements 500 which are distributed along the perimeter of the volume 300. The locking elements 500 comprise a locking spring 502 which presses against a locking post 501. The locking spring 502 may be part of the shaping element 12 and the locking post may be part of the second carrier 20. A locking actuator 510 is arranged to switch between the open 52 and the closed 51 state. In the embodiments shown in FIGS. 1 to 3, the locking actuator 510 comprises an SMA wire, which contracts along its main extension direction, when the SMA wire is heated above a threshold temperature. In particular the SMA wire may be heated by applying a current to the locking actuator 510. The locking actuator pulls the locking springs 502 in a radial direction towards the optical axis 100, which reduces the normal force acting between the locking spring 502 and the locking post 501. Thus, the locking element, in particular the locking unit 50 is switched to the open state 52, when power is supplied to the locking actuator 510. The locking elements 500 may comprise separately addressable locking actuators 510 or a single locking actuator 510 extending around the entire perimeter of the first carrier 10.

In the embodiment shown in FIG. 1, the locking spring 501 comprises two leaf springs per locking post 501. The leaf springs are monolithically integrated in the shaping element 12.

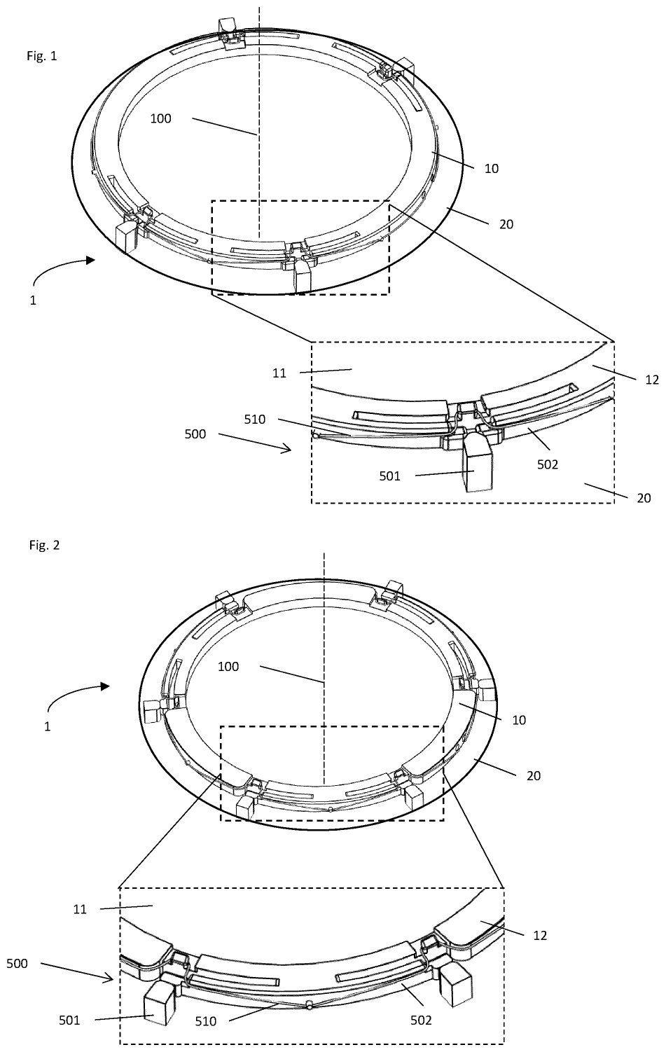

In the embodiment shown in FIG. 2, the locking spring 502 comprises one leaf spring per locking post 501, wherein the leaf spring has a single attachment point. The leaf springs are monolithically integrated in the shaping element 12. In particular, the locking elements 500 are arranged symmetrically with respect to the optical axis 100. For example, the locking actuator 510 is arranged to control the state of opposed locking elements synchronously. Thus, opposed locking elements 500 are in the same state.

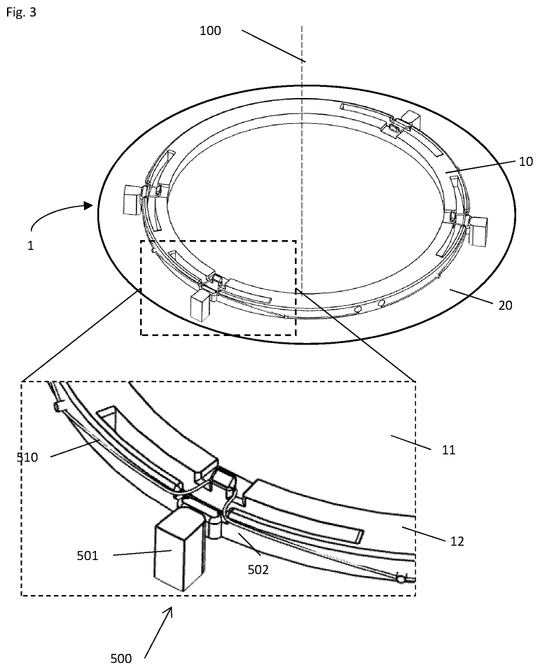

In the embodiment shown in FIG. 3, the locking spring 502 comprises one leaf spring per locking post 501, wherein the leaf spring has two attachment points.

As shown in the exemplary embodiments of FIGS. 1 to 3, the locking unit is arranged to provide locking forces which act on the first 10 and/or second 20 carrier, and the locking forces are in force equilibrium so that the resulting force is zero. In particular, the locking forces do not result in a motion of the first carrier 10 with respect to the second carrier 20 along the optical axis 100.

Preferably the locking forces do not result in relative motion of the first carrier 10 with respect to the second carrier 20 in directions obliquely with respect to the optical axis 100.

In particular, switching between the open and the closed state of the locking unit 50 does not change the relative position of the first carrier 10 and the second carrier 20 with respect to each other. For example, switching between the closed state and the open state does not alter the position of the first carrier 10 with respect to the second carrier 20 along the optical axis 100.

The locking unit comprises multiple locking elements 500, wherein each locking element is arranged to apply a locking force to the first carrier 10 or the second carrier 20 in a direction perpendicular to the optical axis 100, and wherein the locking elements are distributed along the perimeter of the volume 30.

The FIGS. 4 and 5 show exemplary embodiments of the tunable optical component 1, wherein the locking unit 502 comprises a locking spring 502. The locking spring 502 extends around the perimeter of the first carrier 10. The locking spring 502 has a circular shape as seen in a top view along the optical axis 100. In a locked state, the locking spring 502 rests against the surface of the first carrier 10. In other words, in the locked state the locking spring 502 exerts a locking force in a radial direction against the first carrier 10.

The locking unit 50 comprises the locking actuator 510, which is arranged to increase the inner diameter of the locking spring to switch from the closed state 51 to the open state 52. The locking actuator 510 applies a force in a direction tangential to the locking spring 502 as seen in a top view along the optical axis. The increased diameter of the locking spring 502 reduces the radial force between the locking spring 502 and the first carrier 10. The locking actuator comprises a SMA-wire which is arranged to contract when heated above a threshold temperature.

In the embodiment shown in FIG. 5, the locking spring 502 has a circular shape and the locking spring acts in a radial direction away from the optical axis. In a locked state, the locking spring rests against the second shaper 20. The locking actuator 510 comprises a SMA-wire which is arranged along the perimeter of the locking spring 502 and rests against the locking spring 502. When a current is applied to the locking actuator 510, the SMA-wire contracts and reduces the diameter of the circularly shaped locking spring 502. The reduced diameter reduces the friction between the locking spring 502 and the second shaper, which allows relative motion of the locking spring 502 with respect to the second carrier 20.

Preferably the locking unit 50 is in the closed state when no power is supplied to the locking unit 50 and the locking unit 50 is in the open state when power is supplied to the locking unit 50. In other words, the locking unit has a so called “active open” geometry. Alternatively, the locking unit 50 may be arranged to be in the open state when no power is supplied to the locking unit, which corresponds to a so called “active closed” geometry. The active closed geometry is particularly relevant in cases where the power consumption of the locking unit smaller than the power consumption of the actuator for maintaining a tuning state of the tunable optical component 1.

In the closed state the locking unit 50 connects the first carrier 10 and the second carrier 20 by means of a form fitting connections and/or by means of a force fitting connection. The locking unit 50 comprises elastic elements, in particular a locking spring 502, which exert normal forces on surfaces of the first 10 and/or second 20 carrier to provide a force fitting connection between the first 10 and second 20 carrier. Furthermore, the locking unit 50 may comprise surfaces with interlacing structure, like a ratchet structure, wherein the relative motion of the first 10 and second 20 carrier is predominantly impeded by means of a form fitting connection between the first carrier 10 and the second carrier 20. The formfitting connection is releasable by means the locking actuator 510.

FIG. 6 shows an exemplary embodiment of a tunable optical component 1, in particular a tunable lens, in a schematic sectional view. The tunable optical component 1 is a transmission based tunable optical component which interacts with electromagnetic radiation, in particular visible light, by refraction, wherein at least one optical property of the optical component is controllable.

The tunable optical component 1 comprises a first carrier 10 and a second carrier 20, wherein the first carrier 10 is movable with respect to the second carrier 20. At least one of the first and the second carrier, in particular both the first and the second carrier comprise an optical surface of the tunable optical component. Here and in the following an optical surface is a surface which is arranged to interact with electromagnetic radiation in an intended manner.

The tunable optical component 1 comprises a volume 30 filled with a liquid, wherein the volume is arranged between the first carrier 10 and the second carrier 20 along an optical axis 100 of the optical component 1. The locking unit 50 is not shown in this embodiment.

FIGS. 7A and 7B show the tunable optical component 1, which is biased by means of the membrane 11. In FIG. 7a, the tunable optical component is in a non-tuned. In the non-tuned state the actuator 40 does not alter the optical properties and the membrane 11 is bulged convexly. Also the elastic membrane 81, which delimits the volume 30 laterally, is bulged convexly. In the non-tuned state, the pressure in the volume 30 is larger than the ambient pressure. The actuator 40 comprises a shape memory alloy providing an actuation force and a retention element providing a retention force, wherein the retention force is opposed to the actuation force. In the embodiment of FIGS. 7A and 7B, the retention element comprises an elastic membrane 81. Tuning the optical component, as shown in FIG. 7B, reduces the distance between the first carrier 10 and the second carrier 20 by means of the actuator 40, which increases the pressure in the volume 30. The increased pressure alters the shape of the membrane 11, which changes the optical properties of the tunable optical component 1, wherein the tension of the elastic membrane 81 is increased when the pressure in the volume 30 is increased by means of the actuation force. The tension in the elastic membrane 81 provides the retention force.

According to one embodiment, the tunable optical component is a tunable lens, wherein the first carrier is deformable in a direction along the optical axis, and the actuator is arranged to alter a shape of the first carrier along the optical axis by applying an actuation force.

According to one embodiment the first carrier comprises a flexible membrane and a shaping element, wherein the membrane comprises a first optical surface of the tunable optical component. The shaping element extends perimetrically around the first optical surface and the shaping element is elastically deformable in a direction along the optical axis. The actuator is attached to the shaping element at multiple actuation points, and the actuator is arranged to control a shape of the first optical surface by adjusting a position of the shaping element at the actuation points with respect to the second carrier in a direction along the optical axis at each actuation point individually. The tunable optical component comprises at least six actuation points to control at least one of the following optical properties: sphere, prism and/or astigmatism.

According to one embodiment the number of locking elements equals at least the number of actuation points, and each of said locking elements is arranged to impede relative motion of one of the actuation points with respect to the second carrier in a direction along the optical axis individually.

According to one embodiment, the locking unit is arranged to impede relative motion of all actuation points simultaneously. In particular, the locking unit comprises a single locking actuator, which is arranged to control the switch between the closed and open state synchronously (FIG. 5.) FIG. 8 shows an exemplary embodiment of the tunable optical component 1 in a schematic side view. As shown in the embodiment in FIG. 8, the retention element 80 comprises a spring element which pushes the first carrier and the second carrier apart. The spring element comprises a leaf spring 821 extending perimetrically around the volume 30.

FIG. 9 shows an exemplary embodiment of the tunable optical component 1 in a schematic side view. The embodiment shown in FIG. 9 differs from the embodiment shown in FIG. 8 in the retention element 80 comprising spiral springs in stead of leaf springs 821.

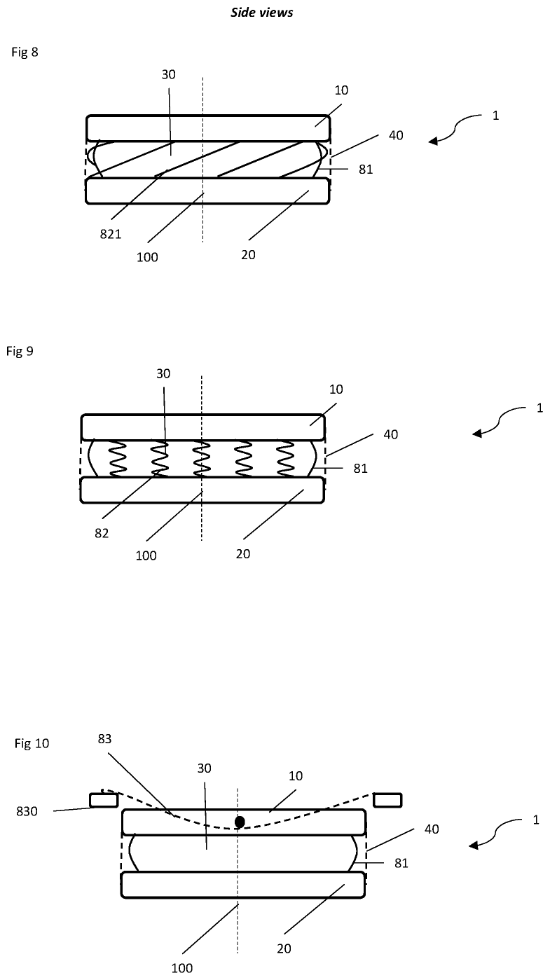

FIG. 10 shows an exemplary embodiment of the tunable optical component 1 in a schematic side view. The embodiment shown in FIG. 10 comprises a retention actuator 83 providing the retention force. The retention actuator 83 comprises a shape memory alloy, which is arranged to pull the first carrier 10 apart from the second carrier 20 along the optical axis 100. Alternatively, the retention actuator may comprise an electro-permanent magnet or a reluctance actuator.

FIG. 11 shows an exemplary embodiment of a tunable optical component 1 in a schematic perspective view. The actuator 40 comprises an SMA-wire 420, wherein the SMA wire 420 is guided along the perimeter of the liquid volume 30, and the length of the SMA-wire 420 along its main extension direction is larger than the distance between the first 10 and the second carrier 20. The distance between the first 10 and the second carrier 20 is measured along the optical axis 100. In particular, the SMA-wire is deflected at least once by resting against the first 10 and/or second carrier 20. The SMA wires 420 are attached to the actuation points 400, which provide the mechanical connection between the first 10 or second 20 carrier and the SMA wire 40. The relative position of the actuation points 400 along the perimeter of the first 10 and the second 20 carrier determines the angle Advantageously, guiding the SMA wire 420 along the perimeter of the lens, increases the stroke which may be achieved by means of the actuator 40. In the embodiment in FIG. 11, the locking unit is not shown for the sake of simplicity.

FIG. 13 shows an exemplary embodiment of a tunable optical component 1 in a schematic side view. The actuator 40 comprises multiple SMA wires 420. The multiple SMA wires 420 have a common electrical connection through the first carrier 10. In particular, the first carrier is at least partially electrically conductive. The SMA wires are individually addressable by applying a current to the end of the SMA wire which is opposed to the first carrier 10.

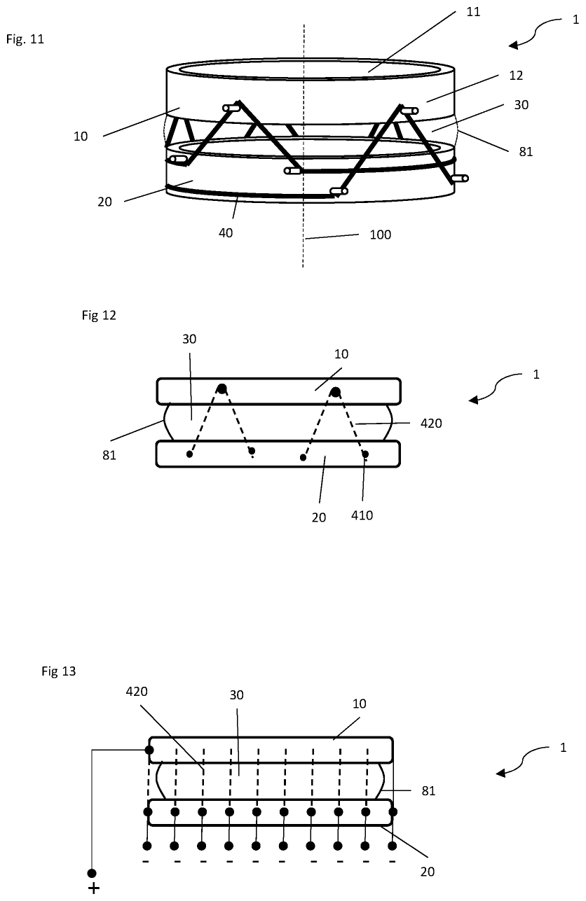

FIG. 14 shows an exemplary embodiment of the tunable optical component 1 in a schematic perspective view. The tunable optical component 1 comprises an actuator 40 which is arranged to move the first carrier 10 with respect to the second carrier 20 by means of an actuation force, wherein movement of the first carrier 10 with respect to the second carrier 20 changes a shape of the volume 30. In particular, the application of the actuation force results in an adjustment of the alignment of the optical surface(s) of the first 10 and/or second 20 carrier with respect to incident light, or the application of the actuation force results in a change of a shape of the optical surface(s) of the first and/or second carrier. Similar to the embodiments shown in FIGS. 11 and 12, the SMA wire 420 rests at pins 410, which form actuation points 400, against the first 10 and second 20 carrier.

FIG. 15 shows an exemplary embodiment of a tunable optical component 1 in a schematic side view. The actuator 40 comprises multiple pulling ropes, wherein each pulling rope is attached to a different actuation point 400. Each pulling rope comprises a different SMA wire 420 and a passive wire 430. The SMA wire 420 is wrapped around the second carrier 20. Thus, the SMA wire rests against the second carrier 20 and extends along the perimeter of the volume 30. The locking unit 50 comprises a wire, which is wrapped around the second carrier 20, and which extends across the pulling ropes. The locking unit 50 is arranged to clamp the pulling ropes between the second carrier 20 and the locking unit, to lock the tunable optical component 1 in a determined tuning state. In particular, the tuning state of all actuation points is locked simultaneously. This type of actuator is described in connection with the German patent application 102021105705.1, the content of which is included by reference.

According to one embodiment the tunable optical component comprises a position sensing unit, which is arranged to detect a relative position of the first carrier with respect to the second carrier. The position sensing unit may comprise a hall sensor, which is arranged to determine relative position of the first carrier with respect to the second carrier (FIG. 15).

According to one embodiment, the position sensing unit 62 is arranged to detect the relative position of each actuation point with respect to the second carrier.

FIGS. 16 and 17 show exemplary embodiments of the tunable optical component, wherein the locking unit 50 comprises at least three locking elements 500. In particular, the first carrier 10 and the second carrier 20 are at least partially rigid. In this context, partially rigid refers to the portion of the first/second carrier which is being interfaced by means of the actuator 40 and/or the locking unit 50. Each of the locking elements 500 is arranged to define a relative position of one point of the first carrier 10 with respect to the second carrier 20 along the optical axis 100. The tunable optical component comprises a hinge 70, which determines an axis of rotation 71 of the first carrier 10 with respect to the second carrier 20. For example, the actuator is attached to a single point of the first carrier and at most to two points of the second carrier (FIGS. 16 and 17).

According to one embodiment the axis of rotation extends tangentially along the volume as seen in a top view along the optical axis. In particular, the axis of rotation does not extend through the center of the volume as seen in a top view along the optical axis.

The tunable optical component 1 is a tunable lens, and the first carrier comprises the flexible membrane 11 and the shaping element 12, wherein the membrane 11 comprises the first optical surface of the tunable optical component 1. The shaping element extends perimetrically around the first optical surface, and the shaping element is rigid in a direction along the optical axis 100. The actuator 40 is arranged to control a shape of the first optical surface by adjusting a position of the shaping element with respect to the second carrier 20 in a direction along the optical axis (FIGS. 16 and 17).

The locking unit 50 comprises locking actuator 510 which arranged to switch between the open and the closed state, wherein the locking actuator comprises one of a shape memory alloy, an electro-permanent magnet or a reluctance actuator. In particular, the locking actuator 510 comprises a shape memory alloy (SMA), which has a wire shape with a main extension direction. The SMA is arranged to contract along the main extension direction when exceeding a transition temperature. For example, the wire is heated above the transition temperature, by applying a current to the wire.

The tunable optical component 1 comprises an accelerometer 60 for measuring an acceleration force acting onto the tunable optical component and a control unit 61 controlling the switch between open and closed state of the locking unit 50, wherein the control unit is arranged to switch the locking unit in the closed state when the accelerometer detects an acceleration force above a threshold acceleration force value. The threshold acceleration force value may be 1 G, preferably 1.5 G or 3 G. Thus, the locking unit may prevent relative motion of the first and the second carrier when it is exposed to high acceleration forces, like in a drop event.

According to one embodiment, an adjustment of the relative position of the first carrier and the second carrier alters the pressure of the liquid in the volume, which causes the membrane to bend.

According to one embodiment the tunable optical component is a tunable prism and the first carrier and the second carrier are rigid transparent elements, and the actuator is arranged to tilt the first carrier with respect to the second carrier.

The invention is not limited to the embodiments by the description based thereon. Rather, the invention encompasses any new feature as well as any combination of features, which in particular includes any combination of features in the claims, even if that feature or combination itself is not explicitly stated in the claims or embodiments.

### LIST OF REFERENCE SIGNS

1 Tunable optical component
10 First carrier
11 Membrane
12 Shaping element
20 Second carrier
21 window
30 volume
40 Actuator
50 Locking unit
51 Closed state
52 Open state
60 Accelerometer
61 Control unit
62 Position sensing unit
70 Hinge
71 Axis of rotation
80 Retention element
81 Elastic membrane
82 Spring element
821 Leaf spring
83 Retention actuator
830 mount
100 Optical axis
400 Actuation point
410 Pins
420 SMA-wire
430 Passive wire
500 Locking element
501 Locking post
502 Locking spring
503 Locking ring
504 slit
510 Locking actuator

1. Tunable optical component (1) comprising
A first carrier (10) and a second carrier (20), wherein the first carrier (10) is movable with respect to the second carrier (20),
A volume (30) filled with a liquid, wherein the volume is arranged between the first carrier (10) and the second carrier (20) along an optical axis (100) of the optical component (1),
An actuator (40) which is arranged to move the first carrier (10) with respect to the second carrier (20) by means of an actuation force, wherein movement of the first carrier (10) with respect to the second carrier (20) changes a shape of the volume (30), and
A locking unit (50), wherein the locking unit (50) is arranged to connect the first carrier (10) and the second carrier (20) to one another by means of a releasable connection, wherein in a closed state (51) the locking unit (50) is arranged impede relative motion of the first carrier (10) and the second carrier (20) along the optical axis (100), and
in an open state (52) of the locking unit the first carrier (10) is movable with respect to the second carrier (20) along the optical axis (100) of the tunable optical component (1).

2. Tunable optical component (1) according to claim 1, wherein the locking unit (50) is in the closed state (51) when no power is supplied to the locking unit (50) and the locking unit is in the open state (52) when power is supplied to the locking unit (50).

3. Tunable optical component according to claim 1, wherein in the closed state (51) the locking unit (50) connects the first carrier (10) and the second carrier (20) my means of a form fitting connections and/or by means of a force fitting connection.

4. Tunable optical component (1) according to claim 3, wherein the locking unit (50) is arranged to provide locking forces which act on the first (10) and/or second (20) carrier, and the locking forces are in force equilibrium so that the resulting force is zero.

5. Tunable optical component (1) according to claim 1, wherein switching between the open (52) and the closed state (51) of the locking unit (50) does not change the relative position of the first carrier (10) and the second carrier (20) with respect to each other.

6. Tunable optical component (1) according to claim 1, wherein the locking unit (50) comprises multiple locking elements (500), wherein
each locking element (500) is arranged to apply a locking force to the first (10) or the second (20) carrier in a direction perpendicular to the optical axis (100) and
wherein the locking elements (500) are distributed along the perimeter of the volume (30).

7. Tunable optical component (1) according to claim 6, wherein the locking unit (50) comprises at least three locking elements (500).

8. Tunable optical component (1) according to claim 1, wherein the locking unit comprises locking actuator (510) which arranged to switch between the open (52) and the closed state (52), wherein the locking actuator (510) comprises one of a shape memory alloy, an electro-permanent magnet or a reluctance actuator.

9. Tunable optical component (1) according to claim 1, comprising an accelerometer (60) for measuring an acceleration force acting onto the tunable optical component (1) and a control unit (61) controlling the switch between open (52) and closed (51) state of the locking unit (50), wherein the control unit (61) is arranged to switch the locking unit (50) in the closed state (51) when the accelerometer (60) detects an acceleration force above a threshold acceleration force value.

10. Tunable optical component (1) according to claim 1, wherein
the tunable optical component (1) is a tunable lens,
the first carrier (10) is deformable, and
the actuator (40) is arranged to alter a shape of the first carrier along the optical axis (100) by applying an actuation force.

11. Tunable optical component (1) according to claim 10, wherein
the first carrier (10) comprises a flexible membrane (11) and a shaping element (12), wherein the membrane (11) comprises a first optical surface of the tunable optical component (1),
the shaping element (12) extends perimetrically around the first optical surface,
the shaping element (12) is elastically deformable in a direction along the optical axis (100),
the actuator (40) is attached to the shaping element (12) at multiple actuation points (400), and
the actuator (40) is arranged to control a shape of the first optical surface by adjusting a position of the shaping element (12) at the actuation points (400) with respect to the second carrier (20) in a direction along the optical axis (100) at each actuation point (400) individually.

12. Tunable optical component (1) according to claim 10 wherein the number of locking elements (500) equals at least the number of actuation points (400), and
each of said locking elements (500) is arranged to impede relative motion of one of the actuation points (400) with respect to the second carrier (20) in a direction along the optical axis (100) individually.

13. Tunable optical component (1) according to claim 10, wherein the locking unit (50) is arranged to impede relative motion of all actuation points (400) simultaneously.

14. Tunable optical component (1) according to claim 1 wherein
the tunable optical component is a tunable lens,
the first carrier (10) comprises the flexible membrane (11) and the shaping element (12), wherein the membrane (11) comprises the first optical surface of the tunable optical component,
the shaping element (12) extends perimetrically around the first optical surface,
the shaping element (12) is rigid in a direction along the optical axis (100).
the actuator (40) is arranged to control a shape of the first optical surface by adjusting a position of the shaping element (12) with respect to the second carrier (20) in a direction along the optical axis (100).

15. Tunable optical component (1) according to claim 14, wherein an adjustment of the relative position of the first carrier (10) and the second carrier (20) alter the pressure of the liquid in the volume (30), which causes the membrane (11) to bend.

16. Tunable optical component (1) according to claim 12, wherein the first carrier (10) and the second carrier (20) are connected by a hinge (70), wherein the hinge (70) defines an axis of rotation (71) of the first carrier (10) with respect to the second carrier (20).

17. Tunable optical component (1) according to claim 1, wherein
the tunable optical component (1) is a tunable prism,
the first carrier (10) and the second carrier (20) are rigid transparent elements, and
the actuator (40) is arranged to tilt the first carrier (10) with respect to the second carrier (20).

18. Tunable optical component (1) according to claim 1, comprising a position sensing unit (62), which is arranged to detect a relative position of the first carrier (10) with respect to the second carrier (10).

19. Tunable optical component (1) according to claim 1, wherein the actuator (40) comprises an SMA-wire, wherein
the SMA-wire is guided along the perimeter of the volume as seen in top view along the optical axis (100), and
a length of the SMA-wire along its main extension direction is larger than a distance between the first (10) and the second carrier (20).

20. Tunable optical component according to claim 1, wherein the actuator comprises multiple SMA wires, wherein all of the multiple SMA wires a commonly electrically connected through the first or second carrier.
